(19) United States
(12) Patent Application Publication
(10) Pub. No.: US 2023/0363373 A1
(43) Pub. Date: Nov. 16, 2023

(54) DEER ATTRACTION METHODS

(71) Applicant: Wildlife Research Center, Inc., Ramsey, MN (US)

(72) Inventor: Samuel A. Burgeson, Andover, MN (US)

(21) Appl. No.: 17/741,797

(22) Filed: May 11, 2022

(51) Int. Cl. A01M 31/00

(52) U.S. Cl. CPC A01M 31/008

(57) ABSTRACT

The present disclosure describes methods of attracting deer using a novel device configured to hold and support at least one tree branch above the ground, optionally above a deer scrape. The device can include a mounting plate configured for attachment to a mounting object, such as a tree or manually installed post. Two tubular portions, each configured to receive and support at least an end portion of a tree branch, may extend from a common surface of the mounting plate. One of the tree branches may serve as an interaction branch upon which deer may deposit natural scents formulated to attract other deer. A deer attractant device, such as a liquid scent dispenser, may be suspended from one of the tree branches supported by the device to deposit the attractant on the interaction branch and/or scrape.

### FIELD OF THE INVENTION

Implementations relate to deer attraction methods and associated devices. Specific implementations include a device configured to attract deer by supporting tree branches above the ground, at least one of which may serve as a deer interaction branch positioned above a deer scrape.

### BACKGROUND

Hunters and photographers often use various animal attractants to increase their chances of getting close to animals. In some cases, attractant scents can be used in ways that take advantage of the natural mating processes of certain species. For example, in the case of the white-tail deer, a buck will often prepare a “scrape” to attract a doe by scraping the ground with his hooves and depositing urine thereon. A doe may be attracted to the scrape due to the urine scent, where the doe may also urinate, thereby indicating her receptiveness to mating. Other territorial bucks also may visit the scrape, which may alert the original buck of the presence of the other deer. Outdoor enthusiasts may thus prepare scent-laden mock scrapes to entice deer to a particular location.

While mock scrapes can be useful for attracting deer, their effectiveness is often limited by their location and the means for scent deposition. Natural scrapes are frequently positioned near trees having low-hanging branches, where natural deer scents are replenished over time as deer rub against such branches. Novel methods of mimicking this setting are needed to enhance deer attraction techniques with minimal human intervention.

### SUMMARY

The present disclosure provides mounting devices configured to mimic natural sites of deer attraction by supporting tree branches above the ground, for example over a natural or artificial deer scrape. Embodiments of the device may include tubular portions each configured to receive at least an end portion of a tree branch or stick. The device may be mounted to a variety of objects, including trees or user-installed posts, thereby expanding the locations at which deer can be attracted. At least one of the branches secured by the device may be positioned to serve as an interaction or licking branch upon which deer may deposit natural scents detectable by other deer. Another tree branch held by the device can be positioned above the interaction branch, where it may be used to suspend various deer attractants, such as liquid scent dispensers or visual lures. Associated methods of attracting deer involve loading and mounting the device near or over a deer scrape.

In accordance with at least one example disclosed herein, a method of attracting deer to a site may involve mounting a deer attracting device to a mounting object. The deer attracting device may include a mounting plate, a first tubular portion, and a second tubular portion. After mounting, the first tubular portion may be positioned below the second tubular portion. The method may also involve inserting an end portion of a first tree branch into the first tubular portion, and inserting an end portion of a second tree branch into the second tubular portion.

In some examples, the method may also involve hanging a scent dispenser from the second tree branch. In some examples, the mounting object may be a tree, a post, a stake, and/or a building structure. In some examples, the method may also involve creating a mock deer scrape below the first tree branch. In some examples, the mounting object may be located adjacent to a natural deer scrape. In some examples, mounting the deer attracting device to the mounting object may involve fastening the deer attracting device to the mounting object with at least one screw. In some examples, the first tubular portion may extend from the mounting plate at a first angle, and the second tubular portion may extend from the mounting plate at a second angle, the second angle being different than the first angle. In some examples, the second angle may be steeper than the first angle. Examples may further involve adjusting a mounting height of the deer attracting device on the mounting object. Examples may also involve securing the end portion of the first tree branch within the first tubular portion and the end portion of the second tree branch within the second tubular portion by inserting and tightening a screw within a circumferential wall of each of the first tubular portion and the second tubular portion.

In accordance with at least one example disclosed herein, a deer attracting device may include a mounting plate configured for attachment to a natural or artificial mounting object, along with a first tubular portion and a second tubular portion both extending from a common surface of the mounting plate. The first tubular portion may extend from the common surface of the mounting plate at a first angle, and the second tubular portion may extend from the common surface of the mounting plate at a second angle, different than the first angle. The device may also include at least one support portion extending between the tubular portions, between the tubular portions and the common surface of the mounting plate, or both.

In some examples, the mounting object may be a tree, a post, a stake, and/or a building structure. In some examples, the first tubular portion, the second tubular portion, the mounting plate, and the at least one support portion may be integrally formed into a single body of unitary construction. In some examples, the first and second tubular portions may be positioned along the same vertical plane, such that after mounting the deer attracting device to a mounting object, the first tubular portion may be positioned below the second tubular portion. In some examples, the second angle may be steeper than the first angle with respect to the ground. In some examples, the first tubular portion and the second tubular portion do not converge. In some examples, at least a portion of the first tubular portion and the second tubular portion do converge. In some examples, the first tubular portion and the second tubular portion may each comprise a branch securing mechanism. The branch securing mechanism may comprise a threaded through-hole configured to accommodate a complementary fastener. In some examples, the mounting plate may comprise at least one screw hole extending through an entire cross-sectional thickness of the mounting plate. In some examples, at least a portion of the device may comprise a polycarbonate resin.

### BRIEF DESCRIPTION OF THE DRAWINGS

While the specification concludes with claims particularly pointing out and distinctly claiming the subject matter that is regarded as forming the various embodiments of the present invention, it is believed that the invention will be better understood from the following description taken in conjunction with the accompanying Figures, in which:

FIG. 1 is a depiction of a deer attracting device mounted to a post and holding two tree branches in accordance with embodiments of the present disclosure.

FIG. 2A is a perspective view of a deer attracting device in accordance with embodiments of the present disclosure.

FIG. 2B is a side view of the deer attracting device shown in FIG. 2A in accordance with embodiments of the present disclosure.

FIG. 3 is a side view of another deer attracting device in accordance with embodiments of the present disclosure.

FIG. 4 is a schematic of a method of attracting deer in accordance with embodiments of the present disclosure.

The drawings are not necessary to scale. Certain features and components may be shown exaggerated in scale or in schematic form, and some details may not be shown in the interest of clarity and conciseness.

### DETAILED DESCRIPTION

The following description of certain examples is in no way intended to limit the disclosure or its applications or uses. In the following Detailed Description of examples of the present devices and associated methods of use, reference is made to the accompanying drawings which form a part hereof, and in which are shown by way of illustration specific examples in which the described embodiments may be implemented. These examples are described in sufficient detail to enable those skilled in the art to practice the presently disclosed embodiments, and it is to be understood that other examples may be utilized and that structural or procedural changes may be made without departing from the spirit and scope of the present disclosure. Moreover, for the purpose of clarity, detailed descriptions of certain features will not be discussed when they would be apparent to those skilled in the art so as not to obscure the description of the present disclosure. The following detailed description is therefore not to be taken in a limiting sense, and the scope of the present systems and methods is defined only by the appended claims.

Provided herein are novel devices and associated methods of attracting deer using the same. Embodiments of the device can include two tubular portions extending from a mounting plate, which can be attached to various natural or artificial outdoor objects, such as trees or installed posts. Each of the tubular portions can receive and secure an end portion of at least one tree branch. The tubular portions are arranged such that after mounting the device to a mounting object, one tubular portion can be considered the upper tubular portion and the other can be considered the lower tubular portion. The tree branch inserted into the lower tubular portion can serve as an “interaction branch” positioned for deer to rub against, smell, or otherwise engage with. Such engagement may result in the deposition of natural deer scent detectable by other deer, which may be attracted to the attraction site as a result. The tree branch inserted into the upper tubular portion can be used to mount or suspend various deer attractants, such as liquid scent dispensers and/or visual lures. Methods of attracting deer using a disclosed device may thus involve mounting the device to a mounting object via the mounting plate, inserting a tree branch into each of the tubular portions, and optionally attaching or hanging a deer attractant to the branch supported by the upper tubular portion. Methods may also involve mounting the device near a natural or mock deer scrape, such that the supported tree branches extend over the scrape. Positioning the device in this manner can enhance the level of deer attraction achieved using the devices disclosed herein.

By using the disclosed devices, users can avoid securing interaction branches to the ground, where the branches are vulnerable to physical damage. Anchoring the devices to preexisting or manually installed mounting objects relatedly increases the durability of the devices and enables mounting at a variety of heights, such that users can select and adjust the height of the interaction branch as desired. Additional devices, e.g., motion-sensor cameras, can be attached to the mounting objects to expand the objectives accomplished at a single attraction site. The devices can be of unitary construction or may require a small number of components, rendering them simple to manufacture. Specialized or custom fasteners may be unnecessary, such that ordinary screws or bolts may suffice to secure the devices to mounting objects and firmly support one or more tree branches.

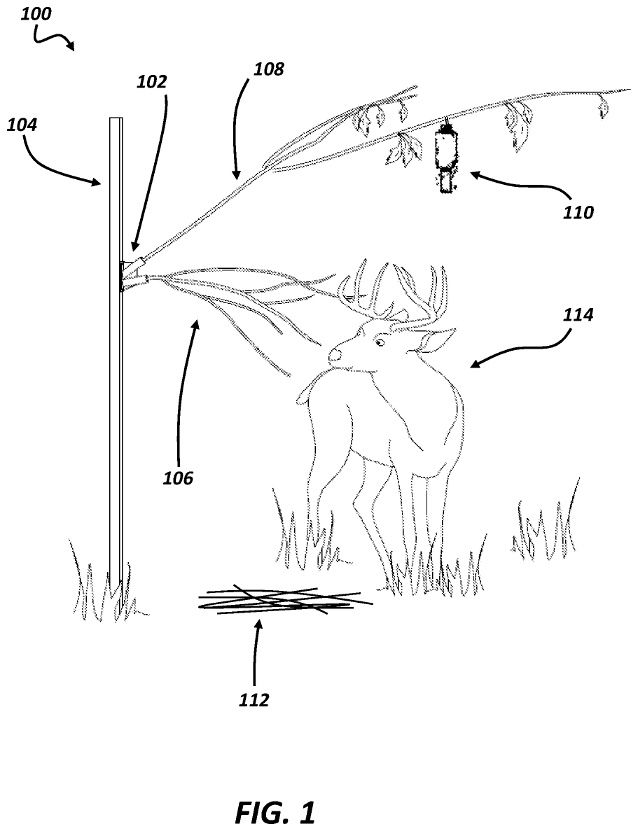

Referring to the drawings, FIG. 1 illustrates a deer attraction site 100 featuring a deer attracting device 102 attached to a mounting object 104, which in the illustrated example comprises a stake or post. An interaction branch 106 and an upper branch 108 are each supported by the device 102, and a liquid scent dispenser 110 is suspended from the upper branch 108. The branches 106, 108 are positioned above a deer scrape 112, which may be natural or artificial. A deer 114 is shown near the scrape 112 interacting with the interaction branch 106. Because it can be difficult to find an acceptable tree having utilizable branches extending over a deer scrape, especially at a particularly desired location, the device may provide a valuable mechanism for suspending branch(es) therefrom.

The attraction site 100 can be selected by a user. In examples featuring a mock scrape 112, the attraction site 100 can be created wherever a user desires, within reason. In examples featuring a natural scrape 112, the attraction site 100 can be created near the scrape 112. While the mounting object 104 shown in this particular embodiment is a post, various other mounting objects can be used to secure the device 102. Non-limiting examples of mounting objects compatible with the disclosed devices may include: tree trunks, tree stumps, vertical supports of deer stands, stakes, poles, walls of building structures, etc. Substantially vertical mounting objects may be preferred, but diagonal or even horizontal mounting objects, such as intact tree branches, may also be utilized.

The device 102 can be attached to the mounting object 104 at a height that positions the interaction branch 106 near the height of an approximately average sized deer. Positioning the device 102 in this manner may allow the deer 114 to physically contact at least a portion of the interaction branch 106, or get close enough to the interaction branch 106 to detect a scent deposited thereon by the deer attractant 110 or another deer. In various embodiments, the device 102 may be secured to the mounting object 104 at a height of about 2.5 feet, 3 feet, 3.5 feet, 4 feet, 4.5 feet, 5 feet, 5.5 feet, 6 feet, 6.5 feet, 7 feet, or higher, or any height therebetween.

The branches 106, 108 can be selected at least in part by their rigidity and length. A substantially rigid upper branch 108 may be chosen to provide adequate support for the deer attractant 110 hanging therefrom. The rigidity of the interaction branch 106 may be the same or similar to that of the upper branch 108 in some examples, or slightly less in others. For instance, the interaction branch 106 may be relatively flexible to withstand physical contact of the deer 114 without breaking, but also rigid enough to avoid drooping. Additional embodiments may feature one or more artificial branches or sticks comprised of reusable materials. One or both branches 106, 108 can be replaced periodically, as necessary, to maintain the desired configuration of the site 100, including the height of the branches 106, 108.

Liquid scents included in the liquid scent dispenser 110 may include, but are not limited to: doe urine, doe estrous secretions, and buck urine. The scent formulations may be artificial or natural, and may be used during any period of time that is suitable, which may not be limited to mating season of any particular animal.

In some examples, one or more surfaces of the device 100 may feature a woodgrain appearance. Embodiments of the device 100 may be camouflage. In some examples, at least a portion of the exterior surface of the device 100 may be textured or scored to resemble natural tree bark or branches.

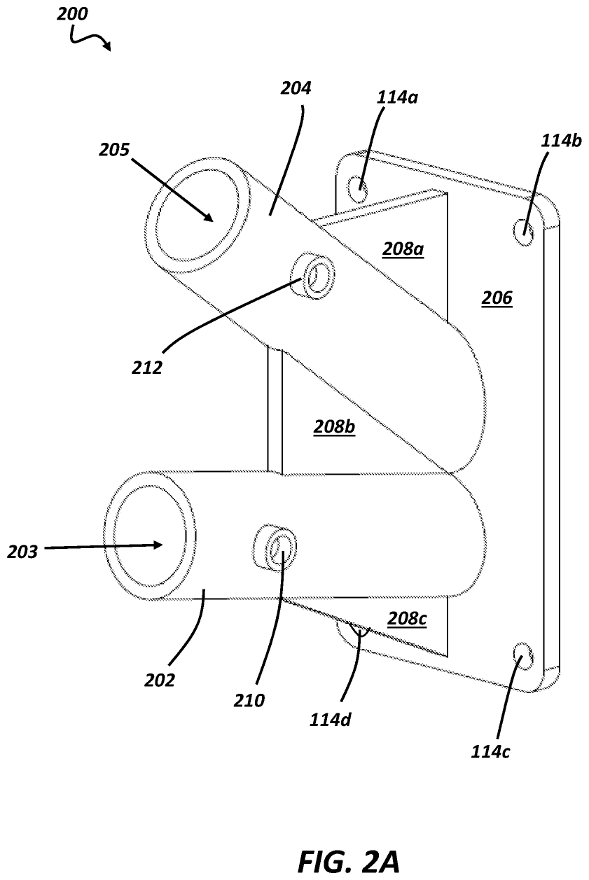

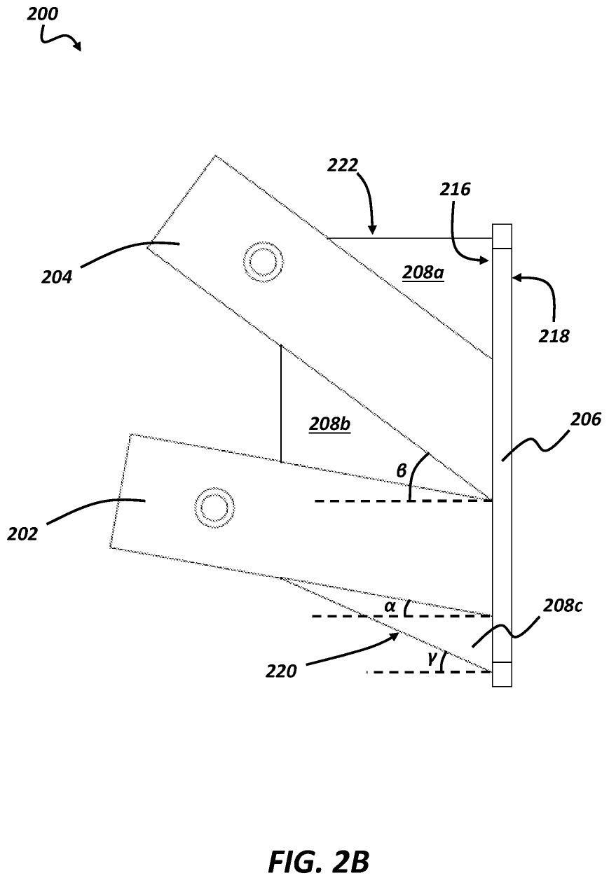

A magnified perspective view of a deer attracting device 200 is illustrated in FIG. 2A in an upright position. As shown, the device 200 may include a first or lower tubular portion 202 and a second or upper tubular portion 204, both of which may be connected to or formed integrally with a mounting plate 206. The lower tubular portion 202 defines an inner lumen 203, and the upper tubular portion likewise defines an inner lumen 205. Above, between, and below the tubular portions 202, 204 are tubular support portions 208a, 208b, 208c. The tubular support portions 208a, 208b, 208c may appear as segments of a single plate protruding away from and approximately perpendicular to the mounting plate 206, but the tubular support portions 208a, 208b, 208c may not penetrate the lumens 203, 205. In some examples, one or more of the tubular support portions 208a, 208b, 208c may be omitted, although the inclusion of at least two, if not all three tubular support portions 208a, 208b, 208c may be important to maintain the structural integrity of the device 200 over time. For instance, tubular support portion 208c may be critical to support the lower tubular portion 202, especially if an interaction branch inserted therein is relatively heavy and/or if the branch will remain mounted in the lower tubular portion 202 for a prolonged period of time. Accordingly, the tubular support portions 208a, 208b, 208c may reinforce the tubular portions 202, 204 and increase the durability of the device 200 as a whole.

Each tubular portion 202, 204 can include a branch retaining mechanism, which in the illustrated embodiment features a through-hole or aperture 210, 212 configured to receive a fastener, e.g., screw or wing bolt, to tighten and secure the branch inserted within each tubular portion 202, 204. An inner surface of each aperture 210, 212 may be threaded to accommodate a complementary threaded portion of each fastener. Tightening of the fastener further secures each branch inserted into a tubular portion. In the embodiment shown, each aperture 210, 212 spans the cross-sectional width of the wall of each tubular portion 202, 204 and protrudes from an outer surface of each tubular portion 202, 204. In other embodiments, one or both apertures 210, 212 may not protrude from the outer surface of one or both tubular portions 202, 204, such that the outer and inner ends of the apertures are flush with the respective outer and inner surfaces of the tubular portions. While a single branch retaining mechanism may suffice to adequately secure the branches, additional branch retaining mechanisms can be utilized, non-limiting examples of which may include pin releases, springs, etc.

The cross-sectional shape of each tubular portion 202, 204 may also vary. In the embodiment shown, each tubular portion 202, 204 is cylindrical, but in other embodiments, the cross-sectional shape of each tubular portion may be approximately rectangular, square, triangular, or irregular. The cross-sectional diameter of each tubular portion 202, 204, and thus the inner lumens 203, 205 thereof, may be approximately constant along the length of each tubular portion 202, 204. In additional examples, the inner diameter of one or both tubular portions 202, 204 may vary along the length of the tubular portion(s), such that the tubular portions taper in one direction. For example, the cross-sectional diameter of the distal end of a tubular portion furthest from the mounting plate 206 may be greater than the inner diameter at or near the mounting plate 206. Tapered tubular portions may be utilized to cinch the inserted branches at or near the mounting plate 206, thereby supplementing the securing force provided by the branch retaining mechanisms.

The cross-sectional width or diameter defined by the inner surface of each tubular portion 202, 204 may vary, provided the width is large enough to accommodate at least one branch. Embodiments may include tubular portions having cross-sectional widths of about 0.5 inches, 1 inch, 1.5 inches, 2 inches, 2.5 inches, 3 inches, 3.5 inches, 4 inches, 4.5 inches, 5 inches, 5.5 inches, 6 inches or more, or any width therebetween.

The mounting plate 206 may include at least one screw hole configured to receive a complementary screw for securing the mounting plate 206, and thus the device 200 as a whole, to a mounting object, such as the stake or post shown in FIG. 1. The illustrated embodiment includes four screw holes 214a, 214b, 214c, 214d, but this number may vary, such that embodiments may include one, two, three, five, six, seven, or eight screw holes, or more. Embodiments may also lack screw holes, and may instead feature an alternative or additional mechanism for coupling the device to a mounting object. For example, an elastic strap comprising or resembling a bungee cord, a non-flexible strap or rope, or a zip tie may replace or supplement the screw hole(s).

The device 200 may be made of a variety of materials. In some examples, at least a portion of the device 200 may comprise one or more polymer compositions, which may be molded into a desired shape, and/or one or more metals or alloys. Specific embodiments of the device 200 may comprise a polycarbonate resin. The composition of the device may render it resistant to cracking or breaking, even in cold weather. In some examples, the body of the device 200 may be slightly flexible to reduce the likelihood of the device cracking or breaking in response to windy conditions or while holding relatively long or heavy branches. Embodiments may lack movable or flexible components, such as springs, which may render the device more resistant to rusting and further increase its durability. Examples of the device can also comprise one or more portions comprised of natural or synthetic wood to mimic the surrounding environment.

As noted above, the device 200 may be of unitary construction or may comprise an assembly of distinct components. A unitary construction may comprise one or more polymer compositions molded into the desired shape. An assembly may feature a body and a separate mounting plate. The body can define the tubular portions, only, or the tubular portions and the tubular support portions. The mounting plate 206 may be made of the same or different material(s) than the tubular portions 202, 204 and/or tubular support portions 208a, 208b, 208c. In some examples, the mounting plate 206 comprises one or more polymer compositions, such as a polycarbonate resin, and/or one or more metals.

FIG. 2B provides a side view of the device 200, showing the lower tubular portion 202 and the second tubular portion 204 extending from the front surface 216 of the mounting plate, opposite the rear surface 218 of the mounting plate 206. Both tubular portions 202, 204 extend diagonally from the front surface of the mounting plate 206. As further shown, the angles between the tubular portions 202, 204 and the mounting plate 206 may be different. In the example shown, both tubular portions 202, 204 are angled with respect to a front surface 216 of the mounting plate 206, which is parallel to the rear surface 218 of the mounting plate 206. The lower tubular portion 202 is arranged at about a 10° angle (α) with respect to the line normal to the front surface 216 of the mounting plate 206. The upper tubular portion 204 is arranged at about a 45° angle (β) with respect to the line normal to the front surface 216 of the mounting plate 206. Accordingly, the angle between the two tubular portions in this example is about 35°.

In various embodiments, the angle α of the lower tubular portion 202 with respect to the line normal to the front surface 216 of the mounting plate 206 may range from about 5° to about 10°, 15°, 20°, 25°, 30°, 35°, 40°, 45°, greater than 45°, or any angle therebetween. The angle β of the upper tubular portion 204 with respect to the line normal to the front surface 216 of the mounting plate 206 may vary from about 5° to about 10°, 15°, 20°, 25°, 30°, 35°, 40°, 45°, 50°, 55°, 60°, 65°, 70°, 75°, 80°, 85°, or any angle therebetween. Angle β may be greater, or steeper, than angle α in some embodiments, such as that shown in FIG. 2B, which may allow the interaction branches mounted by the lower tubular portion 202 to be positioned more horizontally than the upper branch(es) secured by the upper tubular portion 204. This configuration may facilitate interaction between a deer and the interaction branch(es). In other embodiments, the angle α of the lower tubular portion 202 may be steeper than that illustrated in FIG. 2B, which may be preferred if the device 200 must be mounted relatively close to the ground.

The length of each tubular portion 202, 204 may vary. The length of the tubular portions 202, 204 may be the same or substantially the same in some examples, and different in others. For instance, the length of the lower tubular portion 202 and/or the length of the upper tubular portion 204 may range from about 1 inch to about 1.5 inches, 2 inches, 2.5 inches, 3 inches, 3.5 inches, 4 inches, 4.5 inches, 5 inches, 5.5 inches, 6 inches, 6.5 inches, 7 inches, 7.5 inches, 8 inches, 8.5 inches, 9 inches, 9.5 inches, 10 inches or more, or any length therebetween.

The surface area of each tubular support portion 208a, 208b, 208c may also vary. In the illustrated embodiment, tubular support portion 208c is defined by the first tubular portion 202 and an angled lower edge 220. The angled lower edge 220 may extend from the front surface 216 of the mounting plate 206 at an angle γ with respect to the line normal to the front surface 216 of the mounting plate 206. In the example shown, angle γ is about 35°. In embodiments, angle γ may range from about 5° to about 10°, 15°, 20°, 25°, 30°, 35°, 40°, 45°, 50°, 55°, 60°, 65°, 70°, 75°, 80°, or 85°, or any angle therebetween. Similarly, the tubular support portion 208a is defined by the upper tubular portion 204 and a top edge 222. The upper edge 222 may extend from the front surface 216 of the mounting plate 206 at an angle with respect to the line normal to the front surface 216 of the mounting plate 206 ranging from about 0°, as shown, or about −5°, −10°, −15°, −20°, −25°, −30°, −35°, −40°, −45°, −50°, −55°, −60°, −65°, −70°, −75°, −80°, −85°, or about 5°, 10°, 15°, 20°, 25°, 30°, 35°, 40°, 45°, or any angle therebetween.

As further shown in FIG. 2B, the tubular portions 202, 204 may be arranged so that they do not converge, such that the base of the tubular portions 202, 204 remain vertically separated along the front face 216 of the mounting plate 206. Vertical separation between the tubular portions 202, 204 may increase the support provided to the branches inserted therein. Separation of the tubular portions 202, 204 may also facilitate the simultaneous holding of branches within each tubular portion 202, 204. The vertical separation between the tubular portions 202, 204, measured between the tubular portions along the front face 216 of the mounting plate 206 may vary, ranging from about 0.1 inches to about 0.2 inches, 0.3 inches, 0.4 inches, 0.5 inches, 0.6 inches, 0.7 inches, 0.8 inches, 0.9 inches, 1 inch, 1.1 inches, 1.2 inches 1.3 inches, 1.4 inches, 1.5 inches, 1.6 inches, 1.7 inches, 1.8 inches, 1.9 inches, 2 inches, greater than 2 inches, or any di stance therebetween.

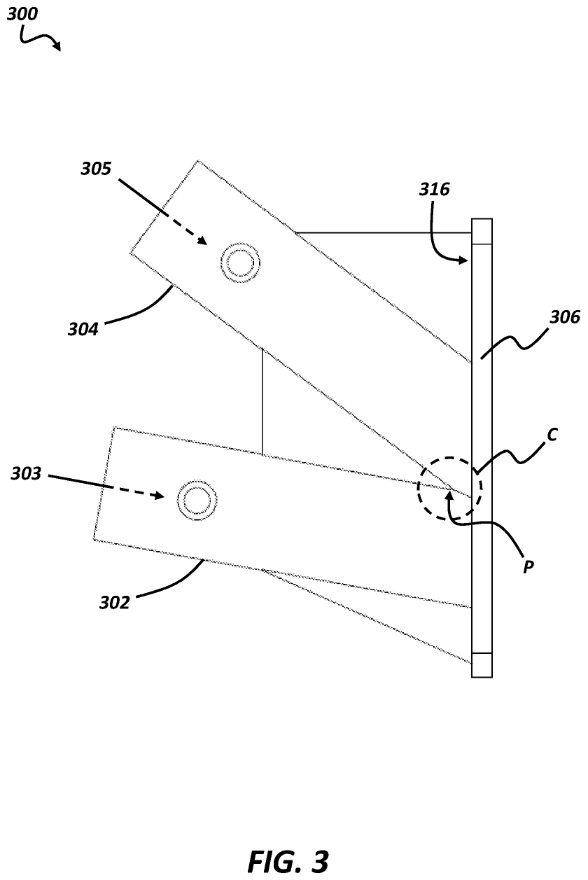

In contrast, the device 300 shown in FIG. 3 includes a first, lower tubular portion 302 that does slightly converge with the second, upper tubular portion 304 near the mounting plate 306, thereby defining a convergence zone C. The inner lumens 303, 305 defined by the respective lower and upper tubular portions 302, 304 may also overlap at the convergence zone C, such that the end portion of each branch inserted into the tubular portions may also overlap. The size of the converge zone C, defined by the front surface 316 of the mounting plate 306 and the distal-most intersection point P between the tubular portions 302, 304, may vary. Measured from the front surface 316 of the mounting plate 306 along the outer surface of the lower tubular portion 302, the intersection point P may be about 0.25 inches from the front surface 316 of the mounting plate 306, or about 0.75 inches, 1 inch, 1.25 inches, 1.5 inches, 1.75 inches, 2 inches, 2.25 inches, 2.5 inches, 2.75 inches, 3 inches or more, or any length therebetween.

The configuration of the rear surface 218, 318 of each mounting plate 206, 306 may vary depending in part on the configuration of the tubular portions 202, 204, 302, 304. The rear surface of the mounting plate may be solid, for example (with the exception of any screw holes), or it may define one or more apertures constituting the proximal ends of the tubular portions. Embodiments featuring non-converging tubular portions may feature two separate holes on the rear surface of the mounting plate, and embodiments featuring converging tubular portions may feature a single hole on the rear surface.

Embodiments of the deer attracting devices disclosed herein may feature more than two tubular portions, such as three, four, five, six, or more tubular portions. Embodiments can also feature tubular portions protruding in multiple directions with respect to the mounting plate. For example, the tubular portions 202, 204 shown in FIGS. 2A and 2B are arranged along a common vertical plane, such that the first tubular portion 202 is positioned directly below the second tubular portion 204 when the device 200 is positioned in an upright orientation. In other embodiments, the tubular portions may be arranged to extend in different directions from the mounting plate 206. Such embodiments may feature a flat or slightly curved mounting plate configured to wrap around at least a portion of the circumference of the mounting object. In some examples, the mounting plate may be configured as a clamp configured to be secured around at least a portion of a mounting object. The clamp can include a tightening mechanism configured to accommodate mounting objects of various widths. Snap-fit mechanisms may also be used.

In some examples, the angle and/or position of the tubular portions can be adjusted. Adjustment of the tubular portions may allow the device to be secured to a variety of mounting objects in a manner that still allows a desired interaction branch height and/or angle to be achieved.

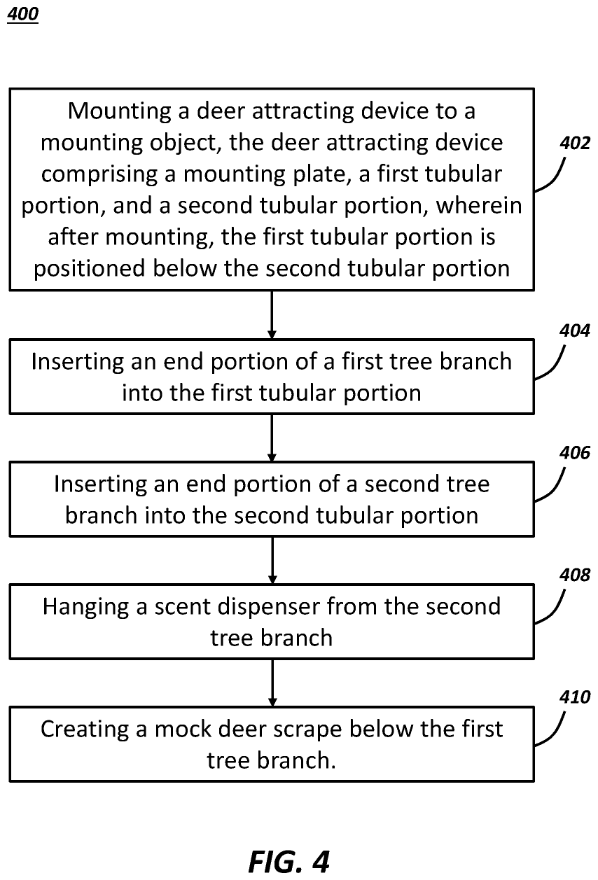

FIG. 4 is a flowchart showing an example method 400 of attracting deer according to embodiments described herein. One or more steps of the method 400 may be performed in a different order than depicted, and additional or fewer steps may be implemented in different examples. As shown, step 402 of the method may involve mounting or coupling a deer attracting device to a mounting object. The deer attracting device can include a mounting plate, a first tubular portion, and a second tubular portion. Mounting the device may involve coupling the device to the mounting object via the mounting plate, which may be configured to accommodate one or more fasteners, such as screws or nails that can be hammered or screwed through the mounting plate and into the mounting object. If the mounting object is artificial, the method 400 may also involve installing the mounting object at a desired location before or after securing the device thereto. After mounting the device in a substantially upright orientation, the first tubular portion may be positioned below the second tubular portion.

At step 404, the method may involve inserting an end portion of a first tree branch into the first tubular portion. Step 406 may involve inserting an end portion of a second tree branch into the second tubular portion, which as noted above, may be located above the first tubular portion. Accordingly, the first tree branch may serve as the interaction branch, and the second tree branch may be considered the upper tree branch. Step 408 may involve hanging a scent dispenser or other deer attractant from the second, upper tree branch. At step 410, the method may involve creating a mock deer scrape below the first tree branch. Embodiments may also involve mounting the deer attracting device above a natural deer scrape.

Although the present disclosure provides references to preferred embodiments, persons skilled in the art will recognize that changes may be made in form and detail without departing from the spirit and scope of the invention. The Detailed Description should be read with reference to the drawings. The drawings show, by way of illustration, specific embodiments of the deer attracting devices and associated methods of use. These embodiments are also referred to herein as “examples.”

Certain terms are used throughout this patent document to refer to particular features or components. As one skilled in the art will appreciate, different people may refer to the same feature or component by different names. This patent document does not intend to distinguish between components or features that differ in name but not in function. For the following defined terms, certain definitions shall be applied unless a different definition is given elsewhere in this patent document. The terms “a,” “an,” and “the” are used to include one or more than one, independent of any other instances or usages of “at least one” or “one or more.” The term “or” is used to refer to a nonexclusive or, such that “A or B” includes “A but not B,” “B but not A,” and “A and B.” All numeric values are assumed to be modified by the term “about,” whether or not explicitly indicated. The term “about” refers to a range of numbers that one of skill in the art considers equivalent to the recited value (i.e., having the same function or result). In many instances, the term “about” can include numbers that are rounded to the nearest significant figure. The recitation of numerical ranges by endpoints includes all numbers and sub-ranges within and bounding that range (e.g., 1 to 4 includes 1, 1.5, 1.75, 2, 2.3, 2.6, 2.9, etc. and 1 to 1.5, 1 to 2, 1 to 3, 2 to 3.5, 2 to 4, 3 to 4, etc.).

What is claimed is:

1. A method of attracting deer to a site, the method comprising:
mounting a deer attracting device to a mounting object, the deer attracting device comprising a mounting plate, a first tubular portion and a second tubular portion, wherein after mounting, the first tubular portion is positioned below the second tubular portion;
inserting an end portion of a first tree branch into the first tubular portion; and
inserting an end portion of a second tree branch into the second tubular portion.

2. The method of claim 1, further comprising hanging a scent dispenser from the second tree branch.

3. The method of claim 1, wherein the mounting object comprises a tree, a post, a stake, and/or a building structure.

4. The method of claim 1, further comprising creating a mock deer scrape below the first tree branch.

5. The method of claim 1, wherein the mounting object is located adjacent to a natural deer scrape.

6. The method of claim 1, wherein mounting the deer attracting device to the mounting object comprises fastening the deer attracting device to the mounting object with at least one screw.

7. The method of claim 1, wherein the first tubular portion extends from the mounting plate at a first angle, and the second tubular portion extends from the mounting plate at a second angle, the second angle being different than the first angle.

8. The method of claim 7, wherein the second angle is steeper than the first angle.

9. The method of claim 1, further comprising adjusting a mounting height of the deer attracting device on the mounting object.

10. The method of claim 1, further comprising securing the end portion of the first tree branch within the first tubular portion and the end portion of the second tree branch within the second tubular portion by inserting and tightening a screw within a circumferential wall of each of the first tubular portion and the second tubular portion.

11. A deer attracting device comprising:
a mounting plate configured for attachment to a natural or artificial mounting object;
a first tubular portion and a second tubular portion both extending from a common surface of the mounting plate, wherein
the first tubular portion extends from the common surface of the mounting plate at a first angle, and
the second tubular portion extends from the common surface of the mounting plate at a second angle, different than the first angle; and
at least one support portion extending between the tubular portions, between the tubular portions and the common surface of the mounting plate, or both.

12. The deer attracting device of claim 11, wherein the mounting object comprises a tree, a post, a stake, and/or a building structure.

13. The deer attracting device of claim 11, wherein the first tubular portion, the second tubular portion, the mounting plate, and the at least one support portion are integrally formed into a single body of unitary construction.

14. The deer attracting device of claim 11, wherein the first and second tubular portions are positioned along the same vertical plane, such that after mounting the deer attracting device to a mounting object, the first tubular portion is positioned below the second tubular portion.

15. The deer attracting device of claim 11, wherein the second angle is steeper than the first angle with respect to the ground.

16. The deer attracting device of claim 11, wherein the first tubular portion and the second tubular portion do not converge.

17. The deer attracting device of claim 11, wherein at least a portion of the first tubular portion and the second tubular portion converge.

18. The deer attracting device of claim 11, wherein the first tubular portion and the second tubular portion each comprise a branch securing mechanism, the branch securing mechanism comprising a threaded through-hole configured to accommodate a complementary fastener.

19. The deer attracting device of claim 11, wherein the mounting plate comprises at least one screw hole extending through an entire cross-sectional thickness of the mounting plate.

20. The deer attracting device of claim 11, wherein at least a portion of the device comprises a polycarbonate resin.
